(19) United States
(12) Patent Application Publication
(10) Pub. No.: US 2026/0296578 A1
(43) Pub. Date: Oct. 1, 2026

(54) WEAR RING AND LOCKING HOOK FOR A SEMI-TRAILER COUPLING LOCK OF A SEMI-TRAILER COUPLING OF A TRACTOR UNIT OF A SEMI-TRAILER TRUCK

(71) Applicant: RÜHLICKE GMBH, Hannover (DE)

(72) Inventor: Stefan RÜHLICKE, Hannover (DE)

(73) Assignee: RÜHLICKE GMBH, Hannover (DE)

(21) Appl. No.: 18/998,772

(22) PCT Filed: Jul. 26, 2023
(86) PCT No.: PCT/EP2023/070723

§ 371 Date: Jan. 27, 2025

(30) Foreign Application Priority Data
Aug. 1, 2022 (DE) 102022119205.9
Aug. 24, 2022 (DE) 102022121420.6

(51) Int. Cl. B62D 53/08

(52) U.S. Cl. CPC B62D 53/0885; B62D 53/0857

(57) ABSTRACT

The invention relates to a wear ring or a locking hook for a semi-trailer coupling lock of a semi-trailer coupling of a tractor unit of a semi-trailer truck, said wear ring or locking hook extending substantially about a longitudinal axis (X). The wear ring or the locking hook is characterized by having at least one wear detection means which is oriented perpendicular to the longitudinal axis (X) and is arranged in the wear ring or the locking hook such that wear of the wear ring or the locking hook can be detected optically and/or by sensors perpendicularly to the longitudinal axis (X).

The present invention relates to a wear ring and a locking hook for a semi-trailer coupling lock of a semi-trailer coupling of a tractor unit of an semi-trailer truck according to the preamble of claim 1, a semi-trailer coupling lock with such a wear ring and/or with such a locking hook according to claim 12, a semi-trailer coupling with such a semi-trailer coupling lock according to claim 13, a tractor unit with such a semi-trailer coupling according to claim 14, as well as an semi-trailer truck with such a tractor unit according to claim 15.

Nowadays, various types of motor vehicles are used as road vehicles for the transport of goods. This also includes semi-trailer trucks which are also colloquially referred to as semi-trailers.

An semi-trailer truck is a combination of a tractor unit which can also be called an semi-trailer truck, and a semi-trailer, which can also be called a semi or trailer. The tractor unit is a shortened truck without a loading area, the frame or chassis of which instead has a semi-trailer coupling to accommodate a corresponding attachment of the semi-trailer. The semi-trailer is a comparatively long trailer without a front axle, the front region of which, viewed in the direction of travel, lies from above on the semi-trailer coupling of the frame of the tractor unit and is rotatably held in place by the semi-trailer coupling. The tractor unit can also be called the front vehicle in the direction of traction, travel or movement, and the semi-trailer can also be called the rear vehicle in the direction of traction, travel, driving or movement. The semi-trailer truck can also be called a vehicle combination.

The rotating connection between the tractor unit and the semi-trailer is made possible by a bolt-termed a semi-trailer pin, kingpin or king bolt-as a fastener for the semi-trailer, which is held by the semi-trailer coupling. For this purpose, the cylindrical and rotationally symmetrical semi-trailer pin is fixed in the front region of the frame and points downwards. The semi-trailer coupling consists of a plate with a built-in locking mechanism on which the semi-trailer rests and into which the semi-trailer pin of the semi-trailer is coupled. This means that the semi-trailer is rotatably but securely connected to the tractor unit.

The locking mechanism can also be called a semi-trailer coupling lock and has a C-shaped wear ring which is fixed but replaceably mounted on the semi-trailer coupling plate and is designed and arranged with an interior or receiving space in the longitudinal direction of the tractor unit open to the rear. The locking mechanism also includes a locking hook, also called a coupling hook, which can be pivoted around the vertical axis or longitudinal axis of the inner or receiving space of the wear ring in order to close the inner or receiving space of the wear ring and accordingly hold the semi-trailer pin there. An inner or receiving space of the locking hook therefore corresponds to the inner or receiving space of the wear ring, or these inner or receiving spaces coincide when the locking hook is in a closed state. The longitudinal axis of the semi-trailer pin, the wear ring and the locking hook are then congruent.

To couple or hitch the semi-trailer to the tractor unit, the tractor unit drives backward towards the semi-trailer positioned on semi-trailer supports so that the frame of the tractor unit with the semi-trailer coupling slides under the front region of the frame of the semi-trailer. The semi-trailer pin comes into contact with the outside of the locking hook of the semi-trailer coupling and thereby resiliently pushes the locking hook away swinging it sideways, which causes the semi-trailer coupling to open to the rear. The semi-trailer pin then passes through the opening of the semi-trailer coupling or its wear ring into its interior or receiving space. Then the tractor unit stops, and the opening of the semi-trailer coupling or its wear ring is closed and locked again by swinging the locking hook sideways using spring force. The combination is ready to drive. Uncoupling or unhitching is done in reverse.

The fixed semi-trailer pin of the semi-trailer therefore not only enables a form-fitting hold to the closed semi-trailer coupling of the tractor unit or its semi-trailer coupling lock against the direction of travel or traction, but also a rotational relative movement between the semi-trailer and the tractor unit so that the semi-trailer can follow the movement of the tractor unit even when cornering.

Due to these relative movements of the semi-trailer pin and the semi-trailer coupling to each other, during operation of the semi-trailer truck, abrasion of the material occurs of at least the semi-trailer where the semi-trailer pin comes into contact with the semi-trailer coupling or rubs against the semi-trailer coupling. This abrasion or this wear of the semi-trailer pin reduces its material thickness and accordingly weakens the semi-trailer pin as a transmission element in the power flow between the tractor unit and the semi-trailer. This can lead to a tearing off of the semi-trailer pin.

The relative movements of the semi-trailer pin and the semi-trailer coupling to each other also affect the wear ring and the locking hook of the locking mechanism or the semi-trailer coupling lock, i.e., abrasion and therefore wear also occur on the surfaces of the wear ring and the locking hook which face the particular or common inner or receiving space and are in contact with the cylindrical outer surface of the semi-trailer pin.

Therefore, for the road safety of an semi-trailer truck, it is necessary to regularly check the wear ring and the locking hook of the locking mechanism or the semi-trailer coupling lock for wear, for example at certain intervals for example semiannually or depending on the use of the semi-trailer truck, for example depending on the traveled kilometers. This has so far been done manually, i.e., by a person who measures the dimensions of the wear ring and the locking hook at certain specified locations using a mechanical test gage or template in order to determine whether or not the measured dimensions still meet the corresponding specifications, i.e., whether or not the wear ring and/or the locking hook are already excessively worn and need to be replaced.

The disadvantage of this is that the assessment of permissible or impermissible wear of the wear ring and the locking hook is left to the particular person, and there is therefore a certain uncertainty in that the assessment may also depend on the attentiveness and/or on the experience of the person. This can result in an excessively worn wear ring and/or locking hook to still be used, which can endanger the road safety of the semi-trailer truck. This can also result in a still usable wear ring and/or locking hook being replaced prematurely, which can result in additional effort, additional costs and/or unnecessary downtime of the semi-trailer truck.

Another disadvantage is that the wear of the wear ring and the locking hook can occur very differently and therefore, within the permissible time or kilometer interval between two wear tests, unacceptably strong wear can already be reached without this being able to be detected at that moment. This can also endanger the road safety of the semi-trailer truck.

An object of the present invention is to provide a wear ring and/or a locking hook for a semi-trailer coupling lock of a semi-trailer coupling of a tractor unit of a semi-trailer vehicle of the type described above so that checking the wear of the wear ring and/or the locking hook can be simplified and/or improved. In particular, the wear of the wear ring and/or the locking hook should be able to be monitored more regularly than before and, in particular, even continuously. In particular, this should be as simple, reliable, space-saving, person-independent and/or independent as possible. In any case, this should improve or increase the road safety of the semi-trailer truck. At least an alternative to known options for checking the wear of the wear ring and/or the locking hook of a semi-trailer coupling lock should be created.

The object is achieved according to the invention by a wear ring and/or by a locking hook with the features of claim 1, by a semi-trailer coupling lock with the features of claim 12, by a semi-trailer coupling with the features of claim 13, by a tractor unit with the features of claim 14, and by an semi-trailer truck with the features of claim 15. Advantageous further developments are described in the subclaims.

Accordingly, the present invention relates to a wear ring or a locking hook for a semi-trailer coupling lock of a semi-trailer coupling of a tractor unit of an semi-trailer truck, which extends substantially around a longitudinal axis.

The wear ring according to the invention or the locking hook according to the invention is characterized by at least one wear detection means which is arranged in the wear ring or locking hook perpendicular to the longitudinal axis in such a way that wear of the wear ring or the locking hook perpendicular to the longitudinal axis can be detected visually and/or by sensor. Radially to the longitudinal axis, the wear can thereby be detected facing away from the longitudinal axis, i.e., from an inner or receiving space of the wear ring or the locking hook radially outwards, and/or also radially facing towards the longitudinal axis.

In other words, at least one wear detection means is arranged within the contour or within the material of the wear ring or the locking hook in such a way that both the material of the wear ring or the locking hook and the material of the wear detection means are reduced in their radial extent by the abrasion or wear which occurs during operation as described above due to contact with the semi-trailer pin.

For this purpose, the at least one wear detection means can be arranged exactly radially or perpendicular to the longitudinal axis or at least obliquely to the longitudinal axis in the wear ring or in the locking hook facing inwards towards the semi-trailer pin so that the abrasion or wear of the semi-trailer pin accommodated in the interior or receiving space of the semi-trailer lock can also be reduced by the wear detection means from the inside. Alternatively or additionally, the at least one wear detection means can be arranged exactly radially or perpendicular to the longitudinal axis, or at least obliquely to the longitudinal axis in the locking hook facing outwards towards the semi-trailer pin so that the abrasion or the wear which can occur when the locking hook is resiliently pushed or pivoted away due to the contact with the semi-trailer pin when coupling or hitching can also be reduced by the wear detection means of the locking hook from the outside.

The present invention is based on the finding that by designing a part of the wear ring or the locking hook as or with a wear detection means, the extent of the abrasion or the wear of the wear ring or the locking hook at this point can be made visually recognizable from the outside and/or detectable by sensor. In any case, the condition of the wear detection means can be detected or monitored more easily in this way than was previously possible through regular manual checks of the wear ring or the locking hook itself as described above. This can reduce the effort and accordingly also the cost of checking the extent of wear of the wear ring or the locking hook. This can also increase the reliability of the checking result, which on the one hand increases the road safety of the semi-trailer truck and on the other hand can avoid premature or unnecessary replacement of a still usable wear ring or locking hook. Arranging the wear detection means inside the wear ring or the locking hook can keep the implementation effort and in particular the installation space required therefor to a minimum. In particular, the extent of wear of the wear ring or locking hook can be checked or monitored continuously or much more regularly than previously known, which can increase the road safety of the semi-trailer truck and the duration of use of a wear ring or a locking hook.

Preferably, the wear detection means is arranged in at least one horizontal cavity of the wear ring or the locking hook, wherein the wear detection means has at least a first wear element of a first color, which is arranged between the inner edge of the horizontal cavity and a wear limit. The first color of the wear element differs significantly from the color of the material of the wear ring or the locking hook itself. In other words, at least one colored wear element, in particular made of a colored plastic, can be used as a wear detection means which can be introduced into a corresponding cavity of the wear ring or the locking hook and ends with the contour or surface of the wear ring or the locking hook towards the outside or the inside facing the interior or the receiving space, and can be visually recognized by a person. If the colored wear element has not yet been completely worn away, the colored wear element can be visually identified by the person, and from this, the permissible wear of the wear ring or the locking hook can be concluded. If the colored wear element is no longer visually recognizable to the person, the person can conclude from this that the colored wear element has completely worn away, and that the limit of permissible wear has been reached or exceeded. This can represent a particularly simple implementation of the present invention which can allow a person to regularly visually check the wear. In particular, the driver of the tractor unit, who is to couple a unfamiliar or unknown tractor unit with a wear ring and/or locking hook according to the invention, can easily and quickly visually check the state of wear of the wear ring and/or the locking hook of the semi-trailer coupling lock of the semi-trailer coupling of the tractor unit. This can increase the confidence of the driver in using the unfamiliar or unknown tractor unit.

The wear detection means can also have at least two differently colored wear elements which are arranged radially one behind the other in order to increase the informative value, as will be described in more detail below.

Alternatively or additionally, the wear detection means can enable electronic monitoring of the wear condition or the wear limit of the wear ring or the locking hook, as will be described in more detail below.

In any case, the wear detection means can be arranged at a location in the horizontal plane or in the cross-section of the wear ring or the locking hook at which particularly significant abrasion or wear usually occurs, or at which an unacceptably high wear is usually expected to be reached first. This can accordingly increase the informative value of the wear detection means.

It is also possible to use multiple identical or different wear detection means, viewed in the horizontal plane or in the cross-section of the wear ring or the locking hook, in order to be able to implement the previously described check of wear at a corresponding number of points on the wear ring or the locking hook. In particular, this allows multiple locations, which are usually subject to significant wear, to be monitored for wear simultaneously as described above. In this case, for example, at least one sensory wear detection means can be used at a location on the wear ring or the locking hook which is difficult or impossible for the person or the driver to visually detect. At least one visual wear detection means can be used at a location on the wear ring or the locking hook which is easily or conveniently visibly detectable by the person or the driver.

A plurality of identical or different wear detection means can also be arranged offset from one another in the vertical direction, i.e., along the longitudinal axis, and/or in the horizontal plane or in cross-section, in order to monitor different sections of the wear ring or the locking hook and/or multiple locations of a section of the wear ring or the locking hook as described above, as will be described in more detail below. This can also accordingly increase the informative value of the wear detection means.

According to one aspect of the invention, the wear detection means is arranged in at least one horizontal cavity of the wear ring or the locking hook, wherein the wear detection means has at least a first wear element of a first color, which is arranged between the inner edge of the horizontal cavity and a wear limit, and at least a second wear element of a second, different color, which is arranged within the wear limit.

In this way, the first color of the first wear element can be recognized by the person or by the driver, and the permissible wear of the wear ring or the locking hook can be determined. If the person or the driver visually recognizes the second color of the second wear element, this can indicate impermissible wear of the wear ring or the locking hook.

Accordingly, as a further development of the previously described only one colored wear element, the visually recognized second color of the second wear element can indicate that the second wear element is still present. If only a first colored wear element were used, its absence could be due to the permissible wear limit being reached or also to the fact that the single-colored wear element has become detached and fallen out of the wear ring or locking hook. In this case, a still usable wear ring or locking hook would be considered worn and unnecessarily replaced. This can be avoided by this aspect of the invention.

According to a further aspect of the invention, the wear detection means has at least one lighting means which is arranged within the horizontal cavity of the wear ring or the locking hook and is designed to illuminate the first wear element through the second wear element.

The lighting means can be implemented in particular as an LED. In particular, the operation of the lighting means can be permanent or continuous in order to be able to check the wear condition of the wear ring or the locking hook at any time. Furthermore, the corresponding effort of switching the lighting means on and off or having to provide corresponding electrical options for this, such as an externally accessible switch on the wear ring or locking hook, can be avoided.

The materials of the first and the second wear elements, for example made of plastic, can be accordingly colored and translucent so that the materials of the first and second wear elements can be illuminated radially from the inside or “from behind,” and the light emerges to the outside in the color of the last illuminated wear element. This allows the previously described aspect of the two-colored wear detection means to be further improved in terms of its recognizability and its informative value for the person or the driver since the color can be visually perceived better due to being illuminated. This can make it easier or possible for the person or the driver to visually recognize the wear detection means itself and in particular its color, in particular in the dark, in poor visibility conditions and/or when the surface of the wear ring or the locking hook is dirty.

Providing the wear ring or the locking hook with a horizontal cavity can create sufficient installation space within the wear ring or the locking hook to arrange the at least one lighting means and in particular multiple lighting means there. In particular, a weakening of the wear ring or the locking hook can be sufficiently avoided by means of a correspondingly small horizontal cavity so that the wear ring or the locking hook can perform its force-transmitting function without restriction.

According to a further aspect of the invention, the wear detection means, preferably within the horizontal cavity, has at least one electrical energy storage device which is designed to electrically supply at least the lighting means, preferably also a detection unit and/or a wireless communication unit.

This allows the electrical energy supply of the lighting means and, if applicable, multiple or all lighting means to be provided directly by the wear ring or the locking hook itself so that an electrically conductive connection to the electrical energy supply from outside the wear ring or the locking hook can be dispensed with. This can keep the effort of using at least one lighting means as described above correspondingly low. In particular, when using LEDs as lighting means, which usually have a very low electrical energy requirement, permanent or continuous operation of the lighting means can be guaranteed by the electrical energy storage device even over years so that recharging or replacing the electrical energy storage device can be dispensed with. If necessary, other electrical or electronic components of the wear detection means can also be supplied with electricity from the electrical energy storage device so that the use of additional or separate electrical energy storage devices can be dispensed with.

According to a further aspect of the invention, the wear detection means is arranged in at least one horizontal cavity of the wear ring or the locking hook, wherein the wear detection means has at least a first wear element which is arranged between the inner edge of the horizontal cavity and a wear limit, and at least a second wear element which is arranged within the wear limit, wherein at least one electrically conductive element of an electrical circuit is arranged at the wear limit so that the electrically conductive element is severed by the wear of the wear ring or the locking hook when the wear reaches the wear limit, wherein the wear detection means, preferably within the horizontal cavity, has a detection unit which is designed to monitor the electrical conductivity of the electrically conductive element and, preferably when the electrically conductive element is severed, to output corresponding information.

The two wear elements can be the two single-colored first and second wear elements described above or also two wear elements of any same color.

This aspect of the invention is based on the finding that, in addition to or as an alternative to the previously described visual options of wear monitoring by the person or by the driver, a sensor monitoring option can also be created. For this purpose, an electrically conductive element such as an electrical conductor or an electrical conductor loop can be guided in this way precisely up to the wear limit of permissible wear of the wear ring or the locking hook at this point, which can take place in particular within the second wear element, for example a plastic part, which can simultaneously be covered or protected on the outside by the first wear element, for example a plastic part.

In this case, the first, outer wear element is abraded or worn together with the wear ring or with the locking hook until the wear limit is reached. Upon reaching the wear limit, the electrically conductive element is also subject to abrasion or wear, which acts from the outside on the wear ring or on the locking hook. The electrically conductive element is rubbed off in such a way that it is severed so that the electrically conductive element can no longer transmit electrical current, or no electrical voltage can be applied via the electrically conductive element, which can be recognized by the detection unit. The detection unit can therefore automatically determine when the wear limit has been reached.

The detection unit can output corresponding information to the outside. If multiple wear detection means are used, the information of the detection unit can also contain information which contains that identification of the particular worn or severed electrically conductive element or its detection unit so that the location of the reached or exceeded permissible wear can be recognized.

In any case, the corresponding information can be output by means of a wireless communication unit which can at least wirelessly transmit data or information to the outside of the wear ring or the locking hook and preferably also receive data and information from outside. This can be done automatically by the detection unit as soon as the wear limit is reached so that the person or driver can react to this immediately. This information can be output continuously or repeated regularly by the detection unit to ensure that this information reaches the person or driver. The output of this information by the detection unit can, if necessary, be terminated by an acknowledgment of receipt by the person or driver in order to save electrical energy on the part of the detection unit. The output of this information by the detection unit can, if necessary, additionally or alternatively only occur upon a query or in response to a request from outside, as will be described in more detail below.

In any case, the detection unit can output this information to the person or to the driver in such a way that this information is sent wirelessly to an electronic receiver, such as a mobile device, for example in the form of a smartphone, a tablet or the like, of the person or driver. Additionally or alternatively, this information can also be sent wirelessly by the detection unit to an electronic receiver on the tractor unit, received and further processed there, and then output or displayed to the driver via an output element, such as in particular a display element on the tractor unit. In this case, this information can if necessary be transmitted wirelessly from the tractor unit or its control unit to a fleet management system in order to be able to take into account and plan the replacement of the worn wear ring or the worn locking hook there.

According to a further aspect of the invention, the wear detection means, preferably within the horizontal cavity, has at least one wireless communication unit, preferably a wireless transmission unit, which is designed to wirelessly transmit at least one item of information from the detection unit to the outside of the wear ring or the locking hook. This allows the corresponding features described above to be implemented.

According to a further aspect of the invention, the wireless communication unit is designed to be requested wirelessly from outside the wear ring or the locking hook to transmit information from the detection unit. This allows the corresponding features described above to be implemented.

According to a further aspect of the invention, the wirelessly sent information of the detection unit contains the state of the electrically conductive element and/or information derived from the state of the electrically conductive element. The state of the electrically conductive element can be distinguished at least as to whether the electrically conductive element is severed or not. Information derived therefrom by the detection unit can be that the corresponding wear limit is recognized as having been reached or not yet reached. However, the latter conclusion can also be drawn where the wirelessly transmitted information of the detection unit is received and further processed, which can simplify the implementation of the detection unit and accordingly save related electrical energy, costs and/or installation space.

According to a further aspect of the invention, the wirelessly sent information of the detection unit further contains an identification of the severed electrically conductive element. This can enable the differentiation of the individual electrically conductive elements even when using a single detection unit.

According to a further aspect of the invention, the wear detection means, preferably at least a first wear element and a second wear element, is arranged at least twice. This can increase the number of locations within the wear ring or locking hook that can be monitored for wear as previously described. Arranging the two wear detection means approximately diametrically opposite each other to the longitudinal axis, i.e., offset by 180° to each other in the plane of the cross section, or offset at as large an angle as possible around the longitudinal axis, can make it possible to monitor the wear as evenly distributed as possible.

According to a further aspect of the invention, the detection unit is designed to monitor the electrical conductivity of all electrically conductive elements and, preferably when at least one of the electrically conductive elements is severed, to output corresponding information. This can obviate the effort of using multiple detection units, while at the same time the one detection unit is designed to be able to monitor all electrically conductive elements. This can simultaneously reduce electrical energy consumption and/or the required installation space.

The invention also relates to a semi-trailer coupling lock with a wear ring and/or with a locking hook as described above. In this way, a semi-trailer coupling lock can be created in order to implement and use the previously described aspects of a wear ring according to the invention and/or a locking hook according to the invention.

The invention also relates to a semi-trailer coupling with a semi-trailer coupling lock as described above. In this way, a semi-trailer coupling can be created in order to implement and use the previously described aspects of a semi-trailer coupling lock according to the invention.

The invention further relates to a tractor unit with a semi-trailer coupling as described above. In this way, a tractor unit can be created in order to therein implement and use the previously described aspects of a semi-trailer coupling according to the invention.

The invention further relates to an semi-trailer truck with a tractor unit as described above. In this way, a tractor unit can be created in order to implement and use the previously described aspects of a tractor unit according to the invention.

Several exemplary embodiments and further advantages of the invention are illustrated and explained in more detail below, purely schematically, in connection with the following figures. In the figures:

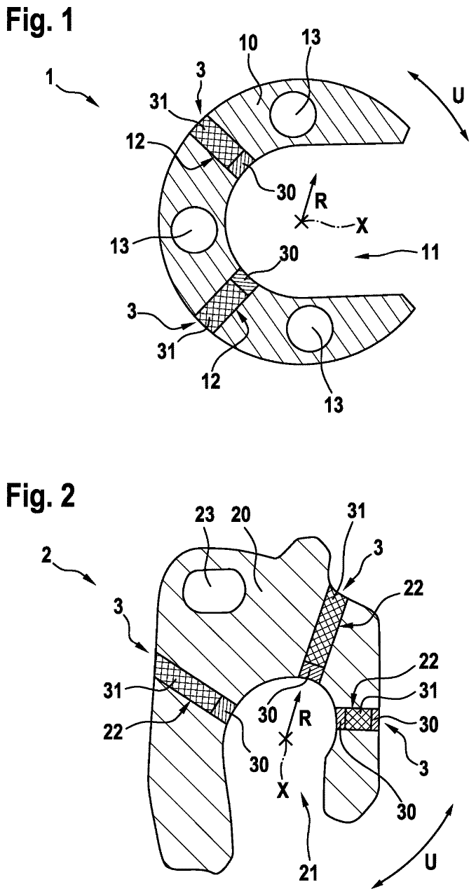

FIG. 1 shows a schematic horizontal section through a wear ring according to the invention in accordance with a first embodiment;

FIG. 2 shows a schematic horizontal section through a locking hook according to the invention in accordance with the first embodiment;

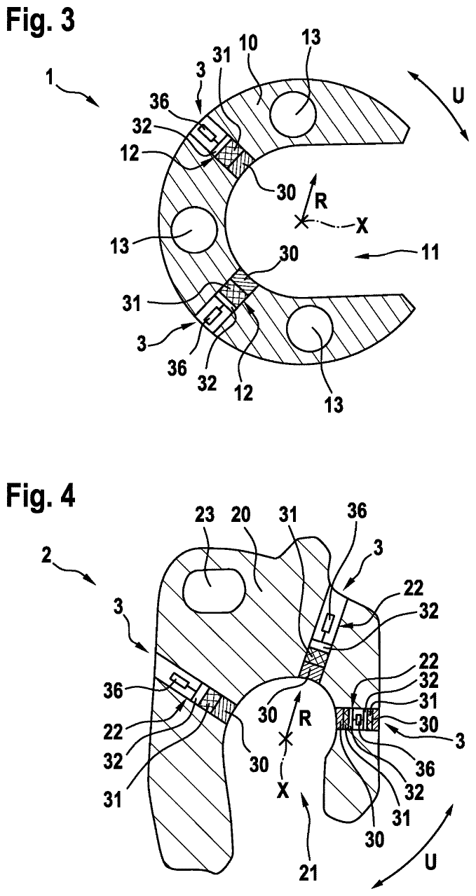

FIG. 3 shows a schematic horizontal section through a wear ring according to the invention according to a second exemplary embodiment;

FIG. 4 shows a schematic horizontal section through a locking hook according to the invention according to the second exemplary embodiment;

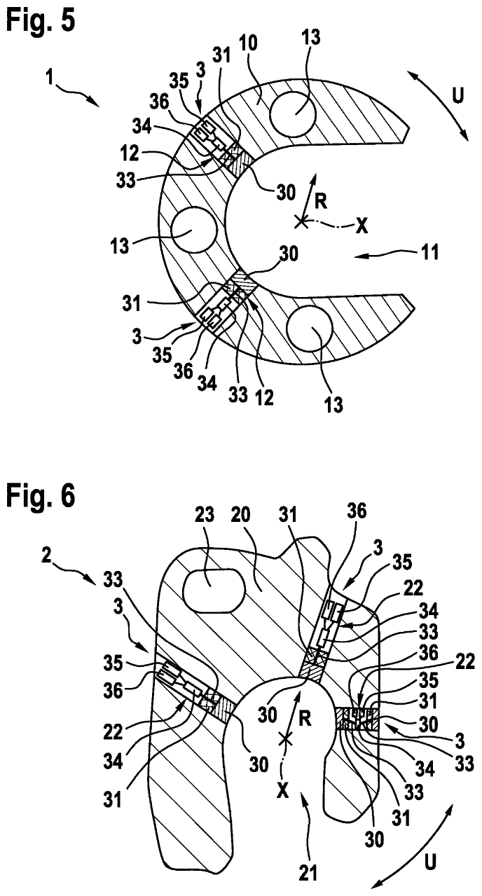

FIG. 5 shows a schematic horizontal section through a wear ring according to the invention according to a third exemplary embodiment;

FIG. 6 shows a schematic horizontal section through a locking hook according to the invention according to the third exemplary embodiment.

The above figures are viewed in cylindrical coordinates. A longitudinal axis X extends. Perpendicular to the longitudinal axis X, a radial direction R extends away from the longitudinal axis X. A circumferential direction U extends perpendicular to the radial direction R and around the longitudinal axis X.

FIG. 1 shows a schematic horizontal section through a wear ring 1 according to the invention in accordance with a first embodiment. FIG. 2 shows a schematic horizontal section through a locking hook 2 according to the invention in accordance with the first embodiment. The locking hook 2 can also be called a coupling hook 2. The wear ring 1 and the locking hook 2, together with other known components not shown, form a semi-trailer coupling lock 1, 2 of a tractor unit (not shown). Both the wear ring 1 as well as the locking hook 2 are made of metal in one piece, i.e., integrally.

The wear ring 1 has a wear ring body 10 which is substantially C-shaped or extends around the longitudinal axis X, see FIG. 1. The wear ring body 10 therefore substantially encloses a receiving space 11 which can also be called the interior space 11 of the wear ring 1. The receiving space 11 has an opening (not designated) radially to the outside. The wear ring body 10 has multiple, for example three, through openings 13, preferably evenly arranged in the circumferential direction U or spaced apart from one another, which serve to mount the wear ring 1, if necessary by means of a fastening ring (not shown), on a plate of the semi-trailer coupling (not shown) by means of screws.

Similarly, the locking hook 2 has a locking hook body 20 which is also designed substantially C-shaped or extends around the longitudinal axis X, see FIG. 2. The locking hook body 20 accordingly also substantially encloses a receiving space 21, which can also be called the interior space 21 of the locking hook 2. The receiving space 21 also has an opening (not designated) radially to the outside. The locking hook body 20 has a through-opening 23 through which a bolt can be guided as a rotation axis in order to pivot the locking hook 2 about the bolt.

The pivotable locking hook 2 is held in a closed position by a spring (not shown), but can be pivoted against the spring force of the spring about the bolt as a pivot axis into an open position. The terms “open” and “closed” refer to whether the openings of the wear ring 1 and the locking hook 2 overlap one another or are substantially congruent and therefore whether the overlapping receiving spaces 11, 21 are accessible for a semi-trailer pin of a semi-trailer (not shown) (“open or opened position”) or whether the receiving space 11 of the wear ring 1 is blocked by the locking hook 2 for the semi-trailer pin (“closed position”).

For this purpose, the locking hook 2 on the plate of the semi-trailer coupling is arranged relative to the wear ring 1 in such a way that the locking hook 2 can be resiliently pressed or pivoted from the closed position into the open position by contact with the semi-trailer pin so that the opening of the wear ring 1 is released, and accordingly the semi-trailer pin of the semi-trailer can be received in the receiving space 11 of the wear ring 1 in the longitudinal direction of the tractor unit as well as the semi-trailer. Then the locking hook 2 whose the opening of the receiving space 21 points laterally towards the semi-trailer pin in the open state, can be pivoted into the closed position by means of its tensioned spring so that the locking hook 2 closes the receiving space 11 of the wear ring 1 in the longitudinal direction of the tractor unit as well as the semi-trailer with its one C-shaped flank and accordingly holds the semi-trailer pin in the receiving space 11 of the wear ring 1. In the closed state, the receiving space 11 of the wear ring 1 and the receiving space 21 of the locking hook 2 therefore coincide or are congruent with each other.

According to the invention, on the one hand, the wear of the wear ring 1 can be checked or monitored at two locations or in two sections, which are each arranged at approximately 45° to the longitudinal direction of the tractor unit as well as the semi-trailer, relative to the receiving space 11 of the wear ring 1 by a person such as the driver of the semi-trailer truck, more easily, more quickly and/or more frequently than previously known. On the other hand, according to the invention, this can additionally or alternatively also be done with regard to the wear of the locking hook 2 at three points or in three sections which are arranged evenly distributed around the longitudinal axis X in the circumferential direction U, opposite the receiving space 21 of the locking hook 2 and additionally or alternatively facing outwards where the semi-trailer pin comes into pressing contact with the closed locking hook 2.

In any case, according to the first exemplary embodiment of FIGS. 1 and 2, at each point of the wear ring 1 or the locking hook 2 to be monitored for wear, there is a continuous horizontal cavity 12 of the wear ring 1 or a continuous horizontal cavity 22 of the locking hook 2 which extends radially or substantially radially from the inside or from the inner surface of the particular receiving space 11, 21 to the opposite outside or outer surface. In each horizontal cavity 12, 22, a wear detection means 3 is introduced which points towards the particular receiving space 11, 21 and is held materially bonded in the horizontal cavity 12, 22, for example by an adhesive between the inner surface of the horizontal cavity 12, 22 and the outer surface of the wear detection means 3, or force-fitting, for example by an at least slight oversize of the outer contour of the wear detection means 3 relative to the horizontal cavity 12, 22. A horizontal cavity 22 of the locking hook 2 further has a second radially outward-facing wear detection means 3 where the semi-trailer pin comes into pressing contact with the closed locking hook 2.

Each wear detection means 3 has a first, outer colored wear element 30 on the edge and, directly adjacent, a second, inner colored wear element 31. The first, outer colored wear elements 30 are materially bonded to the second, inner colored wear elements 31, for example by gluing or by one-piece, i.e., integral, manufacture. The first, outer colored wear elements 30 have a different color than the second, inner colored wear elements 31. Preferably, the first, outer colored wear elements 30 are green, in particular neon green, and the second, inner colored wear elements 31 are red, in particular neon red. The transition or the boundary between a first, outer colored wear element 30 and the corresponding second, inner colored wear element 31 is provided by the dimensioning of the wear elements 30, 31 such that this transition corresponds to the permissible wear limit of the corresponding section of the wear ring 1 or the locking hook 2.

If the tractor unit is parked stationary, i.e., without a semi-trailer, the wear ring 1 according to the invention and the locking hook 2 according to the invention are accessible from all sides in the horizontal plane, at least at the points or sections which have the wear detection means 3, and can be visually viewed from all sides, in particular by the person, such as the driver, who wants to use the tractor unit. In this case, the person can visually recognize the wear detection means 3 of the wear ring 1 and the locking hook 2 and determine whether the first, outer colored wear element 30 or the second, inner wear element 31 is visible from the outside.

If the person recognizes the first, outer colored wear element 30, it can be concluded therefrom that at this point of the corresponding section of the wear ring 1 or the locking hook 2, the wear of the material of the wear ring 1 or the locking hook 2, which also accordingly reduces the particular wear detection means 3 in its radial extension, still lies within a permissible extent. If the person recognizes the second, inner colored wear element 31, it can accordingly be concluded therefrom that at this point or at this section of the wear ring 1 or the locking hook 2, the first, outer colored wear element 30 has completely rubbed off and therefore the second, inner colored wear element 31 located radially underneath is visible from the outside. This means that at this point of the corresponding section of the wear ring 1 or the locking hook 2, the permissible wear has already been reached or exceeded, and the tractor unit can no longer be used in a roadworthy manner. Instead, the wear ring 1 or the locking hook 2 must be replaced.

FIG. 3 shows a schematic horizontal section through a wear ring 1 according to the invention in accordance with a second embodiment. FIG. 4 shows a schematic horizontal section through a locking hook 2 according to the invention in accordance with the second embodiment. The wear elements 30, 31 are designed in different colors as previously described, wherein the particular material is also designed translucent.

Within the particular horizontal cavity 12, 22, a lighting means 32 in the form of an LED 32 is arranged at the inner end of the second, inner colored wear elements 31 in such a way that it is arranged directed radially outwards so that the wear elements 30, 31 are illuminated radially outwards by the light of the particular LED 32 when the LED 32 is operated. The LEDs 32 can be supplied with electrical energy for continuous or permanent operation by an electrical energy storage device 36 in the form of a battery 36 which is also arranged within the particular horizontal cavity 12, 22. The operation of the LEDs 32 can be started when the wear ring 1 or the locking hook 2 is mounted on the tractor unit and can continue until the electrical energy of the battery 36 is used up.

Also in this case of the second exemplary embodiment of FIGS. 3 and 4, the corresponding points or sections of the wear ring 1 or the locking hook 2 can be visually checked for wear by a person as previously described with regard to the first exemplary embodiment of FIGS. 1 and 2. In this case, a light in the color of the first, outer colored wear element 30 can be visually perceived by the person as long as, as described above, the wear limit is maintained. If the wear limit is reached or exceeded at a point or at a section of the wear ring 1 or the locking hook 2, the first, outer colored wear element 30 is rubbed off at this point or at this section, and the light of the corresponding LED 32 emerges outwards in the color of the second, inner colored wear element 31.

Accordingly, the person can distinguish between permissible and impermissible wear based on the color of the light which can be visually perceived at the particular point or particular section of the wear ring 1 or the locking hook 2. As a result, the checking of the wear of the wear ring 1 or the locking hook 2 according to the invention according to the first exemplary embodiment of FIGS. 1 and 2 can be improved for the person in that the colored shining wear detection means 3 can be perceived better or more reliably than without this backlighting, in particular in the dark or in poor visibility conditions such as in rain or fog or also when the outer surface of the wear ring 1 or the locking hook 2 is dirty. In particular, in the dark or in poor visibility conditions, the person can refrain from illuminating the wear ring 1 or the locking hook 2, for example with a flashlight, in order to be able to visually recognize the wear detection means 3. Likewise, the effort of having to clean or wipe a dirty surface of the wear ring 1 or the locking hook 2 in order to be able to visually recognize the wear detection means 3 can be eliminated.

FIG. 5 shows a schematic horizontal section through a wear ring 1 according to the invention in accordance with a third embodiment. FIG. 6 shows a schematic horizontal section through a locking hook 2 according to the invention in accordance with the third embodiment. In this case, the wear ring 1 and the locking hook 2 are designed as described in the second exemplary embodiment of FIGS. 3 and 4, which also applies to the extension of the wear elements 30, 31 which can be colored as described in the first exemplary embodiment of FIGS. 1 and 2, or also can also be designed with the same, indeterminate color.

In each case, an electrically conductive element 33 in the form of a conductor loop 33 extends through the particular second, inner wear element 31 in such a way that the conductor loops 33 run or reverse at the boundary between the first, outer wear element 30 and the second, inner wear element 31. All conductor loops 33 are, individually or jointly, electrically conductively connected to a detection unit 34 which is arranged within the particular horizontal cavity 12, 22 and can also be called a control unit 34. The detection unit 34 is connected to transmit signals to a wireless communication unit 35 which is also arranged within the particular horizontal cavity 12, 22 and can at least transmit wireless signals, which is why the wireless communication unit 35 can also be called a transmission unit 35. Both the detection unit 34 as well as the transmission unit 35 are electrically conductively connected to the particular battery 36 and are operated by the electrical energy of the battery 36.

If in this case the wear of the wear ring 1 or the locking hook 2 reaches the wear limit at a point or at a section of the wear ring 1 or the locking hook 2, the corresponding conductor loop 33 is thereby rubbed off and severed. The detection unit 34 can determine for the particular conductor loop 33 or for each of the conductor loops 33 whether the conductor loop 33 is continuously electrically conductively closed or severed. This can be done, for example, by the detection unit 34 applying a measuring voltage. This enables the detection unit 34 to distinguish for the points or for the sections of the wear ring 1 or the locking hook 2 at which the conductor loops 33 are provided whether or not the wear there still has a permissible level. Corresponding information can be transmitted wirelessly from the detection unit 34 to the outside of the wear ring 1 or the locking hook 2 by means of the transmitting unit 35.

This information can be received and displayed, for example, by a handheld device such as a mobile device such as a smartphone of a person or the driver of the tractor unit. This information can be transmitted continuously, which however can increase the consumption of electrical energy. This information can also only be sent when the person or the driver requests the wear ring 1 or locking hook 2 according to the invention to do so with corresponding information which can also be done by the smartphone. As a result, the corresponding information can be queried when required, which can reduce the electrical energy consumption of the wear ring 1 according to the invention or of the locking hook 2 and accordingly increase the operating time of the detection unit 34 as well as the transmission unit 35.

This information can, for example, also be received by a control unit of the tractor unit and displayed to the driver there. In this case as well, the information by the wear ring 1 or locking hook 2 according to the invention can be transmitted continuously or only after being requested by the control unit of the tractor unit. In any case, the received information can be displayed to the driver of the tractor unit in order to be informed about the roadworthy condition of the wear ring 1 or the locking hook 2, in particular during operation of the tractor unit.

In any case, the detection unit 34 can distinguish between the different conductor loops 33 so that the information sent out can also contain an identification of the particular conductor loops 33. If one of the first, outer wear elements 30 accordingly reaches its limit and the corresponding conductor loop 33 is severed, the person or the driver can be informed specifically at which point or at which section of the wear ring 1 or the locking hook 2 the permissible wear is reached or not reached.

### List of Reference Signs (Part of the Description)

R Radial direction
U Circumferential direction
X Longitudinal axis
1,2 Fifth wheel coupling lock
1 Wear ring of a semi-trailer coupling lock 1, 2
10 Wear ring body
11 Receiving space or interior of the wear ring 1
12 Horizontal cavities of the wear ring 1
13 Through-openings
2 Locking hook or coupling hook of a semi-trailer coupling lock 1, 2
20 Locking hook body
21 Receiving space or interior of the locking hook 2
22 Horizontal cavities of the locking hook 2
23 Through-opening
3 Wear detection means
30 First, external (colored) wear elements
31 Second, inner (colored) wear elements
32 Lighting means; LEDs
33 Electrically conductive elements; conductor loops
34 Detection unit; control unit
35 Wireless communication unit or wireless transmission unit
36 Electrical energy storage device; battery

1. A wear ring or locking hook for a semi-trailer coupling lock of a semi-trailer coupling of a tractor unit of a semi-trailer truck,
extending substantially around a longitudinal axis,
characterized by
at least one wear detection means which is arranged in the wear ring or the locking hook perpendicular to the longitudinal axis in such a way that wear of the wear ring or the locking hook perpendicular to the longitudinal axis can be detected visually and/or by sensor.

2. The wear ring or locking hook according to claim 1, characterized in that
the wear detection means is arranged in at least one horizontal cavity of the wear ring or the locking hook,
wherein the wear detection means
has at least one first wear element of a first color which is arranged between the inner edge of the horizontal cavity and a wear limit, and
at least one second wear element of a second, different color, which is arranged within the wear limit.

3. The wear ring locking hook according to claim 2, characterized in that
the wear detection means has at least one lighting means which is arranged within the horizontal cavity of the wear ring or the locking hook and is designed to illuminate the first wear element through the second wear element.

4. The wear ring locking hook according to claim 3, characterized in that
the wear detection means, preferably within the horizontal cavity, has at least one electrical energy storage device which is designed to electrically supply at least the lighting means, preferably also a detection unit and/or a wireless communication unit.

5. The wear ring or locking hook according to claim 1, characterized in that
the wear detection means is arranged in at least one horizontal cavity of the wear ring or the locking hook,
wherein the wear detection means
at least one first wear element which is arranged between the inner edge of the horizontal cavity and a wear limit, and
at least one second wear element which is arranged within the wear limit,
wherein at least one electrically conductive element of an electrical circuit is arranged is arranged at the wear limit so that the electrically conductive element is severed by the wear of the wear ring or the locking hook when the wear reaches the wear limit,
wherein the wear detection means, preferably within the horizontal cavity, has a detection unit which is designed to monitor the electrical conductivity of the electrically conductive element and, preferably when the electrically conductive element is severed, to output corresponding information.

6. The wear ring locking hook according to claim 5, characterized in that
the wear detection means, preferably within the horizontal cavity has at least one wireless communication unit, preferably a wireless transmission unit, which is designed to wirelessly transmit at least one item of information from the detection unit to the outside of the wear ring or the locking hook.

7. The wear ring locking hook according to claim 6, characterized in that
the wireless communication unit is designed to be requested wirelessly from outside the wear ring or the locking hook to transmit information from the detection unit.

8. The wear ring locking hook according to claim 6, characterized in that
the wirelessly sent information of the detection unit contains the state of the electrically conductive element and/or information derived from the state of the electrically conductive element.

9. The wear ring locking hook according to claim 8, characterized in that
the wirelessly sent information of the detection unit further contains an identification of the severed electrically conductive element.

10. The wear ring or locking hook according to claim 1, characterized in that
the wear detection means, preferably at least a first wear element and a second wear element, is arranged at least twice.

11. The wear ring or locking hook according to claim 10, characterized in that
the detection unit is designed to monitor the electrical conductivity of all electrically conductive elements and, preferably when at least one of the electrically conductive elements is severed, to output corresponding information.

12. A semi-trailer coupling lock with a wear ring and/or with a locking hook according to claim 1.

13. The semi-trailer coupling with a semi-trailer coupling lock according to claim 12.

14. A tractor unit with a semi-trailer coupling according to claim 13.

15. A semi-trailer truck with a tractor unit according to claim 14.
